(19) United States
(12) Patent Application Publication
(10) Pub. No.: US 2009/0162410 A1
(43) Pub. Date: Jun. 25, 2009

(54) Process for preparing fine particle dispersion for wood preservation

(76) Inventors: Jun Zhang, Gertzville, NY (US); Hurny Roman, West Seneca, NY (US)

Correspondence Address: MILBANK, TWEED, HADLEY & MCCLOY LLP, INTERNATIONAL SQUARE BUILDING, 1850 K STRET, N.W., SUITE 1100, WASHINGTON, DC, 20006, US

(21) Appl. No.: 12/071,707

(22) Filed: Feb. 25, 2008

Related U.S. Application Data
(60) Provisional application No. 61/008,557, filed on Dec. 21, 2007.

(51) Int. Cl. A01N 25/04; A01P 15/00; A01P 7/04; B02C 19/06

(52) U.S. Cl. 424/409; 424/486; 241/5

(57) ABSTRACT

The present invention provide a method for producing micronized solid particles through a two-step process. The solid particles of the invention comprise metals or metal compounds, especially copper and copper compounds. The solid particle of the invention further comprise organic biocides. The invention further provides a wood preservative composition and wood comprising the solid particles of the invention, which may be diluted to the target concentration with or without addition of a co-biocide and vacuum/pressure impregnated into a variety wood species including refractory wood species to effectively preserve the material from fungal and insect attack.

This application claims priority to U.S. Provisional Application Ser. No. 61/008,557 that was filed on Dec. 21, 2007, which is hereby incorporated by reference in its entirety.

### FIELD OF THE INVENTION

The present invention relates to a process for preparing fine particle dispersion. More particularly, the invention relates to an efficient process for preparing fine particle dispersions of copper compounds by applying a 2-step wet milling process, with step-one using a 0.2 mm or larger diameter grinding media and step-two using a 0.2 mm or smaller diameter grinding media. The resulting product can not only treat generally sapwood species, such as southern pine, radiate pine, red pine, ponderosa pine and Brazilian pine, but also can treat difficult-to-treat refractory species, such as Douglas fir, hem fir, cedar, redwood and spruce.

### DESCRIPTION OF PRIOR ART

Wood preserving compositions are well known for preserving wood and other cellulose-based materials, such as paper, particleboard, textiles, rope, etc., against organisms responsible for the destruction of wood, namely fungi and insects. Many conventional wood preserving compositions contain copper amine complexes. Copper amine complexes have been used in the past because the amine solubilizes the copper in aqueous solutions. The copper in such copper amine complexes is obtained from a variety of copper bearing materials, such as copper scrap, cuprous oxide, cupric oxide, copper carbonate, copper hydroxide, a variety of cuprous and cupric salts, and copper bearing ores. The amine in such copper amine complexes is normally obtained from an aqueous solution of ammonia and ammonium salts, such as ammonium carbonate, and ammonium sulfate, ethanolamines, et cetera. For example, U.S. Pat. No. 4,622,248 describes forming copper amine complexes by dissolving copper (II) oxide [CuO] (also known as cupric oxide) in ammonia in the presence of ammonium bicarbonate.

The disadvantage of using ammonia as a copper solubilizing agent lies in the strong odor of ammonia. Additionally, copper ammonia preservatives can affect the appearance of the treated wood giving surface residues and undesirable color. In recent years, many amine-containing compounds, such as the ethanolamines and aliphatic polyamines, have been used to replace ammonia to formulate water-soluble copper solutions. These compounds were chosen because of their strong complexing ability with copper and they are essentially odorless. U.S. Pat. No. 4,622,248 discloses a method of preparing copper amine complexes by dissolving a mixture of copper (II) carbonate [CuCO₃] and copper (II) hydroxide [Cu(OH)₂] in ethanolamine and water. The complexing amine (i.e., the ligand) and copper (II) ion combine stoichiometrically and thus the weight ratio of reagents will be different for each complexing amine.

However, copper amine based preservatives have higher copper loss due to leaching as compared to traditional copper based preservatives such as chromated copper arsenate (CCA). Although not entirely certain, the inventors believe the high copper leaching in, for example, Cu-MEA based preservatives is due to the relatively strong complex which forms between the cupric ion and MEA. For example, as much as 25% of copper present in the treated wood can be leached out when wood is treated with a Cu-MEA solution containing 0.5% copper.

As a result, researchers in the area of wood preservation have looked into ways to reduce the leaching of copper while maintaining the penetration of copper into the treated wood. U.S. Patent Publication Nos. 20040258767, 20050118280 and 20060288904 disclosed the concept and method of preparing micronized copper particles for preserving wood with reduced copper leaching from treated wood. Additionally, U.S. Patent Publication Nos. 20040258768, 20050252408 and 20060062926 also disclosed the use of micronized copper particles for treating wood. The copper particles disclosed in these applications can be prepared by one-step wet milling commercially available copper compounds using a certain size of grinding media and an aid of dispersant.

Depending upon the wood species, various sizes of particles are required for effective penetration in wood due to various pore sizes of wood species. Generally speaking, easy-to-treat sapwood pine species, such as southern pine, radiate pine and Brazilian pine have relatively larger pore size, and relatively large particle (i.e., a mean particle size of 0.3 microns) can effectively penetrate into the wood. On the other side, difficult-to-treat refractory wood species, such Hem fir and Douglas fir have much smaller pore size, and small particles (i.e., a mean particle size of 0.10 microns) are required to penetrate effectively.

Commercially available copper compounds, such as, copper carbonate, are generally in technical grade form with large initial particles. The particle size of technical grade copper carbonate can vary from a few microns to a few hundred microns, and occasionally to a few thousand microns. In a one-step milling process where only one particular type of grinding media is used for entire milling process, it is difficult to mill down the size of the technical grade copper compounds to submicron size for treating sapwood pine species, and it is even more difficult and sometimes time/economic prohibitive to mill down the particle size for treating refractory species.

Despite all the efforts to produce submicron size copper particles, there has been an unmet need to effectively produce extremely fine particles that are suitable for use to treat wood, especially for refractory species. This need is solved by the subject matter disclosed herein.

### SUMMARY OF THE INVENTION

The present invention provides a method for producing fine particles of copper compounds through 2-step milling process. In step-one milling process, the slurry mixture of a copper compound and dispersant is milled with 0.2 mm in diameter or larger grinding media, and then in the step-two milling process, the grinding media is changed to a diameter of less than 0.2 mm. The resulting product, when diluted to the target concentration with or without addition of a co-biocide, can be vacuum/pressure impregnated into a variety wood species including refractory wood species to effectively preserve the material from fungal and insect attack.

In one embodiment, the method comprises the steps of (a) providing a solid particle; b) contacting the solid particle with a first grinding media; c) milling the solid particle to produce a first milled particle; d) contacting the first milled particle with a second grinding media; and e) milling the first milled particle to produce a second milled particle.

The solid particle of the invention is a metal or metal compound. In one embodiment, the solid particle is an inorganic biocide. In another embodiment, the metal is copper, cobalt, cadmium, nickel, tin, silver, zinc, lead, bismuth, chromium, or arsenic, or combinations thereof. In preferred embodiment, the metal is copper.

In one embodiment, the metal compound is a copper compound, cobalt compound, cadmium compound, nickel compound, tin compound, silver compound, zinc compound, lead compound, bismuth compound, chromium compound, arsenic compound, or combinations thereof. In preferred embodiment, the metal compound is a copper compound.

In one embodiment, the copper compound of the invention is cuprous oxide, cupric oxide, copper hydroxide, copper carbonate, basic copper carbonate, copper oxychloride, copper 8-hydroxyquinolate, copper dimethyldithiocarbamate, copper omadine, copper borate or combination thereof.

In one embodiment, the solid particle of the invention further comprises one or more organic biocides. The organic biocide may be a fungicide, insecticide, moldicide, bactericide, algaecide, or combinations thereof. The organic biocides include a quaternary ammonium compound, a triazole compound, an imidazole compound, a boron compound, an isothiazolone compound, a pyrethroid compound, or combination thereof. In a preferred embodiment, the organic biocide is imidachloprid, fipronil, cyfluthrin, bifenthrin, permethrin, cypermethrin, chlorpyrifos, iodopropynyl butylcarbamate (IPBC), chlorothalonil, 2-(thiocyanatomethylthio) benzothiazole, alkoxylated diamines or carbendazim.

In one aspect, the first milled particle of the invention is micronized. In a preferred embodiment, the micronized particle has a mean particle size between 0.20 and 2.5 microns. In a more preferred embodiment, the micronized particle has a mean particle size between 0.25 to 0.40 microns.

In another aspect, the second milled particle of the invention has a mean particle size of between 0.005 to 0.20 microns. In one embodiment, the second milled particle has a mean particle size between 0.005 to 0.15 microns. In a preferred embodiment, the second milled particle has a mean particle size between 0.04 and 0.12 microns, or more preferably, between 0.08 and 0.09 microns.

The second milled particle of the invention has a mean particle size of 0.01, 0.02, 0.03, 0.04, 0.05, 0.06, 0.07, 0.08, 0.09, 0.10, 0.20, 0.30, 0.40, 0.50, 0.60, 0.70, 0.80, 0.90 or 1.0 microns. In one embodiment, 90, 91, 92, 93, 94, 95, 96, 97, 98, 99, 99.1, 99.2, 99.3, 99.4, 99.5, 99.6, 99.7 99.8 or 99.9% of the second milled particles are less than 0.2 microns in size. In another embodiment, the second milled particle has a mean particle size less than 0.1 microns. In a preferred embodiment, 99% of the second milled particles are less than 0.2 microns in size. In a more preferred embodiment, 99% of the second milled particles are less than 0.1 microns in size.

In one aspect, the diameter of the first grinding media of the invention is between 0.2 and 2.0 mm. In one embodiment, the diameter of the first grinding media is between 0.3 and 1.0 mm. Preferably, the diameter of the first grinding media is between 0.2 and 0.3 mm, between 0.4 and 0.6 mm, between 0.7 and 1.0 mm, between 1.0 and 1.5 mm, or between 1.5 and 2.0 mm.

In another aspect, the diameter of the second grinding media of the invention is between 0.005 and 0.2 mm. In one embodiment, the diameter of the second grinding media is between 0.05 and 0.15 mm. In another embodiment, the diameter of the second grinding media is between 0.1 and 0.2 mm. Preferably, the diameter of the second grinding media is about 0.1 mm.

The diameter of the first grinding media of the invention may be 0.2 mm or larger. The diameter of the second grinding media may be smaller than 0.2 mm. Preferably, the diameter of the first grinding media is 0.2 mm or larger and the diameter of the second grinding media is smaller than 0.2 mm.

The method of the invention provides that milling time to produce the second milled particle is reduced compared to a milling method comprising only one milling step. Further, provided is the second milled particle prepared by the method of the invention.

In one aspect, the solid particle of the invention further comprises a carrier. In one embodiment, the carrier is aqueous. In another embodiment, the carrier further comprises a dispersant.

The dispersant of the invention may be polymeric. The polymeric dispersant may be used in the slurry of copper compounds for milling process. In one embodiment, the dispersant is an acrylic copolymers, aqueous solution of copolymers with pigment affinity groups, polycarboxylate ether, modified polyacrylate or modified polyacrylate with groups of high pigment affinity, acrylic polymer emulsions, modified acrylic polymers, poly carboxylic acid polymers and their salts, modified poly carboxylic acid polymers and their salts, fatty acid modified polyester, aliphatic polyether or modified aliphatic polyether, solution of polycarboxylate ether, phosphate esters, phosphate ester modified polymers, polyglycol ethers or modified polyglycol ethers, polyetherphosphate, modified maleic anhydride/styrene copolymer, sodium polyacrylate, sodium polymethacrylate, lignin, or modified lignin.

In another aspect, the grinding media of the invention is steel shots, carbon steel shots, stannous steel shots, chrome steel shots, tungsten carbide, silicon nitride, silicon, carbide, ceramic, zirconia, zirconium silicate, zirconium oxide, calcium stabilized zircona, magnesium stabilized zirconia, cerium-stabilized zirconia, stabilized magnesium oxide, yttrium stabilized zirconia, or stabilized aluminum oxide.

Further, provided is a wood preservative composition comprising the second milled particle prepared by the method of the invention.

The invention also provides wood comprising the second milled particle prepared by the method of the invention. In one aspect, wood is resistant to decay and insect attack. In one embodiment, the wood is a sapwood species selected from the group consisting of southern pine, radiate pine, red pine, ponderosa pine, and Brazilian pine. In another embodiment, the wood is a refractory species selected from the group consisting of Douglas fir, hem fir or spruce.

The second milled particle further comprises an organic biocide.

The invention also provides a method to produce uniform distribution of solid particles in wood comprising the step of contacting the composition of the second milled particle with wood.

The invention provides a method of treating cellulosic material comprising the step of contacting the composition of the second milled particle with a cellulosic material.

Also provided in the present invention is a method for using the compositions produced by the 2-step milling. The method comprises the step of contacting a cellulosic material, such as wood, with a composition of the present invention. When the compositions of the present invention are used for preservation of wood, there is minimal leaching of the metal from wood and effective penetration of copper in wood.

### BRIEF DESCRIPTION OF THE FIGURES

FIG. 1 is a comparison of copper leaching from wood treated with a commercial copper based formulation ACQ-Type D and micronized copper carbonate plus dimethyldidecylammonium carbonate/bicarbonate (quat) at preservative retentions of 0.25 pcf and 0.40 pcf. The leaching test was conducted following the procedure described in AWPA Standard E11-97 “Standard Method of Determining the Leachability of Wood Preservatives”.

FIG. 2 depicts the copper penetration in Hem fir treated with a fine particle formulation of copper carbonate plus quat and a solution form of copper formulation ACQ-D. The determination of copper penetration was conducted following the procedures described in AWPA Standard A3-05 “Standard Method for Determining Penetration of Preservatives and Fire Retardants”.

### DETAILED DESCRIPTION OF THE INVENTION

Disclosed herein is a method for the preparation fine particle dispersion of copper compounds by a 2-step milling process, and the resulting product can be used to treat wood including sapwood pine species and refractory species as well. The treated wood has effective copper penetration and minimal copper leaching from the wood.

In the step-one milling process, the slurry mixture comprising a copper compound and a polymeric dispersant is milled with a grinding media with a diameter of 0.2 mm or larger. The feed stock of copper compound can have a particle size in the range of from a few microns to a few hundred microns, and occasionally to a few thousand microns. The preferred media size is in the range of 0.2 to 2.0 mm. Depending upon the initial particle size of the copper compounds, the media can be 0.2-0.3 mm, 0.4-0.6 mm, 0.7-1.0 mm, or 1.0-1.5 mm, or 1.5 to 2.0 mm.

Generally, if the feed stock of copper compound has an initial mean particle size of 5 microns or less, and 99% of the particles are less than 15 microns, then a 0.2-0.3 mm size grinding media will be used; if the feed stock of copper compound has an initial mean particle size of 5 to 15 microns and 99% of the particles are less than 50 microns, then a 0.4-0.6 mm size grinding media will be used; and if the feed stock of copper compounds has an initial mean particle size of 15 to 50 micron, and 50% less than 100 microns, then a 0.7-1.0 mm size grinding media will be used. Through effective grinding, the step-one grinding reduces the particle size to a mean particle size of 0.20 to 2.5 microns with 99% less than 5 microns, and more preferred of 0.25 to 0.40 microns with 99% less than 1.0 micron, and then the slurry is transferred to the step-one grinding.

In the step-two milling process, the slurry mixture obtained in the step-one grinding is milled with a small size grinding media. The diameter of the step-two grinding media is in the range of 0.005 to 0.2 mm, and the preferred size is 0.05 to 0.15 mm, and the most preferred size is 0.1 mm. The step-two grinding further reduces the particle size to a mean particle size of 0.005 to 0.15 microns with 99% less than 0.5 microns, and more preferred of 0.04 to 0.12 microns with 99% less than 0.3 microns, and most preferred of 0.08 to 0.09 microns with 99% less than 0.25 microns.

In both steps, the grinding media can be one or more of many commercially available types, including but not limited to steel shots, carbon steel shots, stannous steel shots, chrome steel shots, tungsten carbide, silicon nitride, silicon, carbide, ceramic (for example, alumina-containing); zirconium-based, such as zirconia, zirconium silicate, zirconium oxide; stabilized zirconia such as yttrium stabilized zirconia, calcium stabilized zircona, magnesium stabilized zirconia, cerium-stabilized zirconia, stabilized magnesium oxide, stabilized aluminum oxide, etc. The preferred grinding media are zirconium based ceramic media, such as zirconia, zirconia silicate, cerium-stabilized zirconia, yttrium stabilized zirconia.

The bulk density of the grinding media is preferably in the range of from 0.5 kg/l to 10 kg/l, and more preferably in the range of from 2 to 5 kg/l. To load a grinding machine with grinding media, the medium preferably occupies 50% to 99% of the grinding chamber volume, with 75 to 95% preferred, and 80 to 90% more preferred. The grinder agitation speed during milling, which can vary with the size of the grinder, is generally in the range of from 1 to 5000 rpm, but can be higher or lower.

Lab and commercial grinders generally run at different speeds. For example, a lab grinding machine with a grinding chamber of 0.5 liters will generally run at a speed of 2000 to 3000 rpm, a mid-size pilot grinding unit of with grinding chamber size of 10 liters will run at a speed of 500 to 1500 rpm, while a commercial grinding unit with a chamber size of 150 liters will run at an agitation speed of 200 to 600 rpm. A set up which involves a transfer pump which repeatedly cycles the slurry between the mill and a storage tank during grinding is convenient. The transfer pump speed varies from 1 to 500 rpm, and the speeds for lab and commercial grinders can be different. During grinding, anti-foam can be optionally added if foaming is observed. During grinding, particle size distribution can be analyzed, and once particle size is within the desired specification, grinding is stopped.

The solid particle of the present invention comprise an inorganic component comprising a metal, metal compound or combinations thereof and optionally one or more organic biocides. Accordingly, the present invention provides micronized solid particle comprising one or more metal or metal compounds with or without one or more organic biocides. When the solid particle comprises both the metal/metal compounds and the organic biocides, the metal or metal compounds or the organic biocides are present as water insoluble micronized particles. In one embodiment, first milled and/or second milled particles of the invention are present as micronized particles.

The metals or metal compounds as well as transition metals or transition metal compounds (including the lanthanide and actinide series elements) such as copper, cobalt, cadmium, nickel, tin, silver, zinc, lead, bismuth, chromium, or arsenic, can be used for the purpose of the invention.

In one embodiment, copper compounds are used in the milling process. Non-limiting examples of copper compounds include cuprous oxide, cupric oxide, copper hydroxide, copper carbonate, basic copper carbonate, copper oxychloride, copper 8-hydroxyquinolate, copper dimethyldithiocarbamate, copper omadine, copper borate or any suitable copper compounds that exhibit a relatively low solubility in the carrier, such as water. For example, a Ksp≦2.5×10⁻².

The copper compounds can be mixed with water or any other carrier and a dispersant to make a pre-grinding slurry. The pre-grinding slurry is then transferred to the grinding chamber pre-filled with step-one media through a transfer pump. After the step-one grinding, the mixture is either transferred into another grinder pre-filled with step-two media for further milling, or the mixture is milled in the grinder with replacement of media to step-two grinding media.

The dispersants used in making grinding slurry for the present invention comprise a polymeric dispersant. We have surprisingly found that the polymeric dispersants can not only provide long-term stability of pigment dispersion particles, but also impart a high degree of stability during repetitive treatment processes. Generally, the weight average molecular weight of the polymeric dispersants varies from a few thousand to 100,000 or even more.

Non-limiting examples of polymeric dispersant classes which can be used in the compositions of the present invention include acrylic copolymers, aqueous solution of copolymers with pigment affinity groups, polycarboxylate ether, modified polyacrylate or modified polyacrylate with groups of high pigment affinity, acrylic polymer emulsions, modified acrylic polymers, poly carboxylic acid polymers and their salts, modified poly carboxylic acid polymers and their salts, fatty acid modified polyester, aliphatic polyether or modified aliphatic polyether, solution of polycarboxylate ether, phosphate esters, phosphate ester modified polymers, polyglycol ethers or modified polyglycol ethers, polyetherphosphate, modified maleic anhydride/styrene copolymer, sodium polyacrylate, sodium polymethacrylate, lignin, modified lignin and the like; modified polyether or polyester with pigment affinic groups; fatty acid derivatives; urethane copolymer or modified urethane copolymer, polyetherphosphate, modified maleic anhydride/styrene copolymer, modified polycarboxylic acid or its derivatives, acrylic acid/maleic acid copolymer, polyvinyl pyrrolidone or modified polyvinyl pyrrolidone, sulfonates or sulfonate derivatives, polymeric alkoxylate or its derivatives, or modified lignin and the like. If desired, a stabilizer as is known in the art can be used. Other dispersants can be found in 2007 McCutcheon's Functional Materials (North American Edition).

We have found that polymeric dispersants, especially modified polycarboxylate ether, modified poly carboxylic acid polymers and their salts, solutions of polycarboxylate ethers; modified polyether or polyester with pigment affinic groups, perform well with copper compounds in providing wetting, dispersing, storage stabilization and stability during treatment process.

For a copper compound, the level of dispersant used in the composition is in the range of from about 0.1 to 180% based on the weight of the copper compound, with a preferred range of 1 to 80%, a more preferred range of 5 to 60%, and a most preferred range of 8 to 20%. If desired, a wetting agent can also be used in the preparation of the compositions of the present invention. The level of wetting agent is in the range of from about 0.1 to 180% of the weight of the biocide compounds, with a preferred range of 1 to 50%, a more preferred range of 5 to 10%.

The composition produced in the present invention can be a concentrate and the concentrate can be further diluted to a target level to treat wood. The total copper compound in the prepared concentrate is in the range of from 1 wt % to 90 wt % based on weight of composition, and preferably in the range of from 5 to 70 wt %, and more preferably in the range of from 30 to 65 wt %.

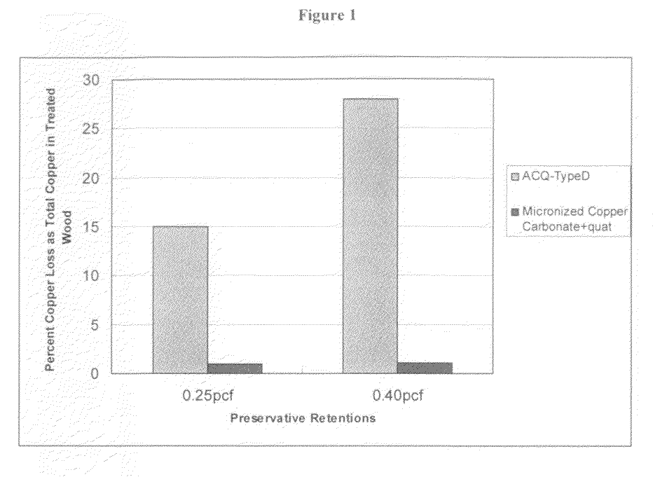

When wood is treated with micronized copper preservatives formulations disclosed herein, copper leaching is significantly reduced. For example, as shown in FIG. 1, when wood treated with a commercial copper based formulation alkaline copper quat (ACQ)-Type D and a micronized copper carbonate plus dimethyldidecylammonium carbonate/bicarbonate (quat) at preservative retentions of 0.25 pcf and 0.40 pcf. The leaching test was conducted following the procedure described in AWPA Standard E11-97 “Standard Method of Determining the Leachability of Wood Preservatives”. It can be seen that wood treated with micronized copper carbonate based formulation demonstrated much greater copper leaching resistance than the wood treated with the commercially available preservative ACQ-Type D.

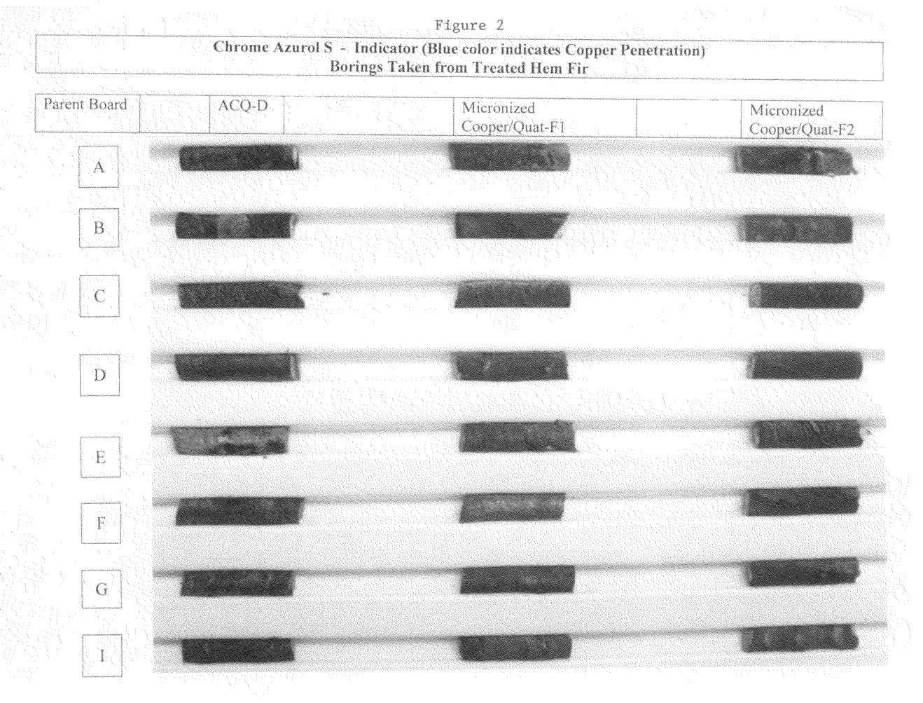

Also important is the penetration of the fine particle copper formulation into the wood. Especially for refractory species, such as Douglas fir and hem fir, if the copper particles have a mean particle size of 0.2 um or bigger, the particles may be filtered by the surface of the wood and thus may not be uniformly distributed within the cell and cell wall. The copper particles prepared in the present invention having a mean particle size of 0.09 microns or less and 100% less than 0.25 microns can have a comparable penetration depth into the refractory species as a solubilized copper formulation, such as ACQ-D. As shown in FIG. 2, the fine copper dispersion present in the current invention demonstrate similar copper penetration into hem fir. The penetration test was conducted following the procedure described in AWPA Standard A3-05 “Standard Method for Determining Penetration of Preservatives and Fire Retardants”.

The present invention also provides a method for preservation of wood. In one embodiment, the method comprises the steps of treating wood with a composition (treating fluid) comprising a dispersion of water insoluble micronized copper compounds. In another embodiment, wood is treated with a composition comprising a dispersion of micronized metal and/or metal compounds and organic biocides, wherein the organic biocides are soluble or present as water insoluble micronized particles or present as emulsion droplet.

The treating fluid may be applied to wood by dipping, soaking, spraying, brushing, or any other means well known in the art. In a preferred embodiment, vacuum and/or pressure techniques are used to impregnate the wood in accord with this invention including the standard processes, such as the “Empty Cell” process, the “Modified Full Cell” process and the “Full Cell” process, and any other vacuum and/or pressure processes which are well known to those skilled in the art.

The standard processes are defined as described in AWPA Standard C1-03 “All Timber Products—Preservative Treatment by Pressure Processes”. In the “Empty Cell” process, prior to the introduction of preservative, materials are subjected to atmospheric air pressure (Lowry) or to higher air pressures (Rueping) of the necessary intensity and duration. In the “Modified Full Cell”, prior to introduction of preservative, materials are subjected to a vacuum of less than 77 kPa (22 inch Hg) (sea level equivalent). A final vacuum of not less than 77 kPa (22 inch Hg) (sea level equivalent) shall be used. In the “Full Cell Process”, prior to introduction of preservative or during any period of condition prior to treatment, materials are subjected to a vacuum of not less than 77 kPa (22 inch Hg). A final vacuum of not less than 77 kPa (22 inch Hg) is used.

Other organic biocides can also be used with the fine particle dispersion of copper compounds. The organic biocides that can be used with copper compounds comprise triazoles such as tebuconazole, cyproconazole, propiconazole, azaconazole, hexaconazole, tetraconazole or simeconazole, imidazoles such as climbazole, imazalil or prochloraz, quaternary ammonium compounds, boron compounds, isothiazolone compounds.

Quaternary ammonium compounds that can be mixed with micronized metal formulations have the following structures:

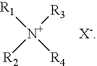

Where R1, R2, R3, and R4 are independently selected from alkyl or aryl groups and X- selected from chloride, bromide, iodide, carbonate, bicarbonate, borate, carboxylate, hydroxide, sulfate, acetate, laurate, or any other anionic group.

Preferred quaternary ammonium compounds include didecyldimethylammonium chloride; didecyldimethylammonium carbonate/bicarbonate; alkyldimethylbenzylammonium chloride; alkyldimethylbenzylammonium carbonate/bicarbonate; didodecyldimethylammonium chloride; didodecyldimethylammonium carbonate/bicarbonate; didodecyldimethylammonium propionate; N,N-didecyl-N-methyl-poly(oxyethyl)ammonium propionate.

Fungicides which can be mixed with micronized metal formulations are:

aliphatic nitrogen fungicides
butylamine;cymoxanil;dodicin;dodine;guazatine;iminoctadine
   amide fungicides
carpropamid; chloraniformethan; cyazofamid;cyflufenamid;diclocymet;ethaboxam; fenoxanil;flumetover;furametpyr;prochloraz;quinazamid;silthiofam;triforine benalaxyl;benalaxyl-M;furalaxyl;metalaxyl;metalaxyl-M;pefurazoate; benzohydroxamic acid;tioxymid;trichlamide;zarilamid;zoxamide
cyclafuramid;furmecyclox dichlofluanid;tolylfluanid benthiavalicarb;iprovalicarb benalaxyl;benalaxyl-M;boscalid;carboxin;fenhexamid;metalaxyl;metalaxyl-M metsulfovax;ofurace;oxadixyl;oxycarboxin;pyracarbolid;thifluzamide;tiadinil benodanil;flutolanil;mebenil;mepronil;salicylanilide;tecloftalam fenfuram;furalaxyl;furcarbanil;methfuroxam flusulfamide
   antibiotic fungicides
aureofungin; blasticidin-S; cycloheximide;griseofulvin;kasugamycin;natamycin;polyoxins;polyoxorim;streptomycin; validamycin azoxystrobin dimoxystrobin fluoxastrobin kresoxim-methyl metominostrobin orysastrobin picoxystrobin pyraclostrobin trifloxystrobin
   aromatic fungicides
biphenyl chlorodinitronaphthalene chloroneb chlorothalonil cresol dicloran hexachlorobenzene pentachlorophenol quintozene sodium pentachlorophenoxide tecnazene
   benzimidazole fungicides
benomyl carbendazim chlorfenazole cypendazole debacarb fuberidazole mecarbinzid rabenzazole thiabendazole
   benzimidazole precursor fungicides
furophanate thiophanate thiophanate-methyl
   benzothiazole fungicides
bentaluron chlobenthiazone TCMTB
   bridged diphenyl fungicides
bithionol dichlorophen diphenylamine
   carbamate fungicides
benthiavalicarb furophanate iprovalicarb propamocarb thiophanate thiophanate-methyl benomyl carbendazim cypendazole debacarb mecarbinzid
diethofencarb
   conazole fungicides
climbazole clotrimazole imazalil oxpoconazole prochloraz triflumizole azaconazole bromuconazole cyproconazole diclobutrazol difenoconazole diniconazole diniconazole-M epoxiconazole etaconazole fenbuconazole fluquinconazole flusilazole flutriafol furconazole furconazole-cis hexaconazole imibenconazole ipconazole metconazole myclobutanil penconazole propiconazole prothioconazole quinconazole simeconazole tebuconazole tetraconazole triadimefon triadimenol triticonazole uniconazole uniconazole-P
   dicarboximide fungicides
famoxadone fluoroimide chlozolinate dichlozoline iprodione isovaledione myclozolin procymidone vinclozolin captafol captan ditalimfos folpet thiochlorfenphim
   dinitrophenol fungicides
binapacryl dinobuton dinocap dinocap-4 dinocap-6 dinocton dinopenton dinosulfon dinoterbon DNOC
   dithiocarbamate fungicides
azithiram carbamorph cufraneb cuprobam disulfiram ferbam metam nabam tecoram thiram ziram dazomet etem milneb mancopper mancozeb maneb metiram polycarbamate propineb zineb
   imidazole fungicides
cyazofamid fenamidone fenapanil glyodin iprodione isovaledione pefurazoate triazoxide
   morpholine fungicides
aldimorph benzamorf carbamorph dimethomorph dodemorph fenpropimorph flumorph tridemorph
   organophosphorus fungicides
ampropylfos ditalimfos edifenphos fosetyl hexylthiofos iprobenfos phosdiphen pyrazophos tolclofos-methyl triamiphos
   oxathiin fungicides
carboxin oxycarboxin
   oxazole fungicides
chlozolinate dichlozoline drazoxolon famoxadone hymexazol metazoxolon myclozolin oxadixyl vinclozolin
   pyridine fungicides
boscalid buthiobate dipyrithione fluazinam pyridinitril pyrifenox pyroxychlor pyroxyfur
   pyrimidine fungicides
bupirimate cyprodinil diflumetorim dimethirimol ethirimol fenarimol ferimzone mepanipyrim nuarimol pyrimethanil triarimol
   pyrrole fungicides
fenpiclonil fludioxonil fluoroimide
   quinoline fungicides
ethoxyquin halacrinate 8-hydroxyquinoline sulfate quinacetol quinoxyfen
   quinone fungicides
benquinox chloranil dichlone dithianon
   quinoxaline fungicides
chinomethionat chlorquinox thioquinox
   thiazole fungicides
ethaboxam etridiazole metsulfovax octhilinone thiabendazole thiadifluor thifluzamide
   thiocarbamate fungicides
methasulfocarb prothiocarb
   thiophene fungicides
ethaboxam silthiofam
   triazine fungicides
anilazine
   triazole fungicides
bitertanol fluotrimazole triazbutil
   urea fungicides
bentaluron pencycuron quinazamid
   Other fungicides
acibenzolar acypetacs allyl alcohol benzalkonium chloride benzamacril bethoxazin carvone chloropicrin DBCP dehydroacetic acid diclomezine diethyl pyrocarbonate fenaminosulf fenitropan fenpropidin formaldehyde furfural hexachlorobutadiene iodomethane isoprothiolane methyl bromide methyl isothiocyanate metrafenone nitrostyrene nitrothal-isopropyl OCH 2 phenylphenol phthalide piperalin probenazole proquinazid pyroquilon sodium orthophenylphenoxide spiroxamine sultropen thicyofen tricyclazole

Preferred insecticides which can be mixed micronized metal formulations are:

antibiotic insecticides
allosamidin thuringiensin spinosad abamectin doramectin emamectin
eprinomectin ivermectin selamectin milbemectin milbemycin oxime moxidectin
   botanical insecticides
anabasine azadirachtin d-limonene nicotine pyrethrins cinerins cinerin I cinerin II jasmolin I jasmolin II pyrethrin I pyrethrin II quassia rotenone
ryania sabadilla
   carbamate insecticides
bendiocarb carbaryl benfuracarb carbofuran carbosulfan decarbofuran furathiocarb dimetan dimetilan hyquincarb pirimicarb alanycarb aldicarb aldoxycarb butocarboxim butoxycarboxim methomyl nitrilacarb oxamyl tazimcarb thiocarboxime thiodicarb thiofanox allyxycarb aminocarb bufencarb butacarb carbanolate cloethocarb dicresyl
dioxacarb EMPC ethiofencarb fenethacarb fenobucarb isoprocarb methiocarb metolcarb mexacarbate promacyl promecarb propoxur
trimethacarb XMC xylylcarb
   dinitrophenol insecticides
dinex dinoprop dinosam DNOC cryolite sodium hexafluorosilicate sulfluramid
   formamidine insecticides
amitraz chlordimeform formetanate formparanate
   fumigant insecticides
acrylonitrile carbon disulfide carbon tetrachloride chloroform chloropicrin para-dichlorobenzene 1,2-dichloropropane ethyl formate ethylene dibromide ethylene dichloride ethylene oxide hydrogen cyanide iodomethane methyl bromide methylchloroform methylene chloride naphthalene phosphine sulfuryl fluoride tetrachloroethane
   insect growth regulators
bistrifluron buprofezin chlorfluazuron cyromazine diflubenzuron flucycloxuron flufenoxuron hexaflumuron lufenuron novaluron noviflumuron penfluron teflubenzuron triflumuron epofenonane fenoxycarb hydroprene kinoprene methoprene pyriproxyfen triprene juvenile hormone I juvenile hormone II juvenile hormone III chromafenozide halofenozide methoxyfenozide tebufenozide α-ecdysone ecdysterone diofenolan precocene I precocene II precocene III dicyclanil
   nereistoxin analogue insecticides
bensultap cartap thiocyclam thiosultap flonicamid clothianidin dinotefuran imidacloprid thiamethoxam nitenpyram nithiazine acetamiprid imidacloprid nitenpyram thiacloprid
   organochlorine insecticides
bromo-DDT camphechlor DDT pp′-DDT ethyl-DDD HCH gamma-HCH lindane methoxychlor pentachlorophenol TDE aldrin bromocyclen chlorbicyclen chlordane chlordecone dieldrin dilor endosulfan endrin HEOD heptachlor HHDN isobenzan isodrin kelevan mirex
   organophosphorus insecticides
bromfenvinfos chlorfenvinphos crotoxyphos dichlorvos dicrotophos dimethylvinphos fospirate heptenophos methocrotophos mevinphos monocrotophos naled naftalofos phosphamidon propaphos schradan TEPP tetrachlorvinphos dioxabenzofos fosmethilan phenthoate acethion amiton cadusafos chlorethoxyfos chlormephos demephion demephion-O demephion-S demeton demeton-O demeton-S demeton-methyl demeton-O-methyl demeton-S-methyl demeton-S-methylsulphon disulfoton ethion ethoprophos IPSP isothioate malathion methacrifos oxydemeton-methyl oxydeprofos oxydisulfoton phorate sulfotep terbufos thiometon amidithion cyanthoate dimethoate ethoate-methyl formothion mecarbam omethoate prothoate sophamide vamidothion chlorphoxim phoxim phoxim-methyl azamethiphos coumaphos coumithoate dioxathion endothion menazon morphothion phosalone pyraclofos pyridaphenthion quinothion dithicrofos thicrofos azinphos-ethyl azinphos-methyl dialifos phosmet isoxathion zolaprofos chlorprazophos pyrazophos chlorpyrifos chlorpyrifos-methyl butathiofos diazinon etrimfos lirimfos pirimiphos-ethyl pirimiphos-methyl primidophos pyrimitate tebupirimfos quinalphos quinalphos-methyl athidathion lythidathion methidathion prothidathion isazofos triazophos azothoate bromophos bromophos-ethyl carbophenothion chlorthiophos cyanophos cythioate dicapthon dichlofenthion etaphos famphur fenchlorphos fenitrothion fensulfothion fenthion fenthion-ethyl heterophos jodfenphos mesulfenfos parathion parathion-methyl phenkapton phosnichlor profenofos prothiofos sulprofos temephos trichlormetaphos-3 trifenofos butonate trichlorfon mecarphon fonofos trichloronat cyanofenphos EPN leptophos crufomate fenamiphos fosthietan mephosfolan phosfolan pirimetaphos acephate isocarbophos isofenphos methamidophos propetamphos dimefox mazidox mipafox
   oxadiazine insecticides
indoxacarb
   phthalimide insecticides
dialifos phosmet tetramethrin
   pyrazole insecticides
acetoprole ethiprole fipronil tebufenpyrad tolfenpyrad vaniliprole
   pyrethroid insecticides
acrinathrin allethrin bioallethrin barthrin bifenthrin bioethanomethrin cyclethrin cycloprothrin cyfluthrin beta-cyfluthrin cyhalothrin gamma-cyhalothrin lambda-cyhalothrin cypermethrin alpha-cypermethrin beta-cypermethrin theta-cypermethrin zeta-cypermethrin cyphenothrin deltamethrin dimefluthrin dimethrin empenthrin fenfluthrin fenpirithrin fenpropathrin fenvalerate esfenvalerate flucythrinate fluvalinate tau-fluvalinate furethrin imiprothrin metofluthrin permethrin biopermethrin transpermethrin phenothrin prallethrin profluthrin pyresmethrin resmethrin bioresmethrin cismethrin tefluthrin terallethrin tetramethrin tralomethrin transfluthrin etofenprox flufenprox halfenprox protrifenbute silafluofen
   pyrimidinamine insecticides
flufenerim pyrimidifen
   pyrrole insecticides
chlorfenapyr
   tetronic acid insecticides
spiromesifen
   thiourea insecticides
diafenthiuron
   urea insecticides
flucofuron sulcofuron
   Other insecticides
closantel crotamiton EXD fenazaflor fenoxacrim hydramethylnon isoprothiolane malonoben metoxadiazone nifluridide pyridaben pyridalyl rafoxanide triarathene triazamate
   Preferred bactericides include:
bronopol cresol dichlorophen dipyrithione dodicin fenaminosulf formaldehyde hydrargaphen 8-hydroxyquinoline sulfate kasugamycin nitrapyrin
octhilinone oxolinic acid oxytetracycline probenazole streptomycin tecloftalam thiomersal

Additional preferred organic biocide comprises a biocide selected from the group consisting of iodopropynyl butylcarbamate (IPBC); chlorothalonil; 2-(thiocyanatomethylthio) benzothiazole; alkoxylated diamines and carbendazim; fludioxonil, thiabendazole, difenoconazole, azoxystrobin, lambda cyhalothrin

Most of the organic biocides are water insoluble. Prior to use, the organic biocides can either dispersed and milled into fine particles in an aid of a dispersant or prepared as an emulsion concentrate, and then combined with fine copper dispersion for treating wood.

The following examples are provided to further describe certain embodiments of the disclosure but are in no way limiting to the scope of disclosure.

Preferred triazole compounds and imidazole compounds for use with the fine copper dispersion prepared in the present invention are tebuconazole; cyproconazole; propiconazole; hexaconazole, 1-[[2-(2,4-dichlorophenyl)-1,3-dioxolan-2-yl]methyl]-1H-1,2,4-triazole; cis-trans-3-chloro-4-[4-methyl-2-(1H-1,2,4-triazol-1-ylmethyl)-1,3-dioxolan-2-yl]phenyl 4-chlorophenyl ether; (RS)-2-(4-fluorophenyl)-1-(1H-1,2,4-triazol-1-yl)-3-(trimethylsilyl)propan-2-ol; 2-(2,4-difluorophenyl)-1-(1H-1,2,4-triazole-1-yl)-3-trimethylsilyl-2-propanol.

Preferred isothiazolone compounds for use with the fine copper dispersion prepared in the present invention are methylisothiazolinone; chloromethylisothiazolinone; 4,5-dichloro-2-n-octyl-3(2H)-isothiazolone; 1,2-benzisothiazolin-3-one; 2-octyl-3-isothiazolone.

### EXAMPLES

The following examples are provided to further describe certain embodiments of the invention but are in no way meant to limit the scope of the invention. Examples 1 through 3 demonstrate a comparison between the one-step grinding process and 2-step grinding process. Examples 4 through 9 demonstrate the 2-step grinding process to obtain the fine particle dispersions of copper compounds. Examples 10 through 11 demonstrate the preparation of wood preservative formulation using the fine particle dispersion of copper compounds for treating wood.

### Example 1

### IA—One-Step Grinding Process

A 5000 g slurry mixture containing 2500 g of copper carbonate, 450 g of commercially available dispersant and 2050 g water was mechanically stirred for 10 minutes and then placed in a lab grinding media mill where a 0.4-0.6 mm Zirstar beads was used. The lab mill was operated at an agitation speed of 2400 to 2650 rpm and a transfer pump speed of 100-150 rpm. The temperature of the slurry was at 30° to 50° C. A sample was taken every 10 minutes for particle size measurement. The particle size was measured on a Horiba LA-910 Particle Size Distribution Analyzer (PSDA). The grinding process stopped at 170 minutes when the target particle size was achieved. The target particle size was set at a mean particle=0.11 microns and 99.0% particles less than 0.3 microns.

### IB—Two-Step Grinding Process

The same copper carbonate mixture was placed in the lab mill and milled as the same condition as described in Example IA. After 40 minutes grinding, the grinding stopped when the mean particle achieved 0.29 microns with 100% particles less than 1.0 micron, and then the 0.4-0.6 mm grinding media were replaced with 0.1 mm YTZ grind media. The grinding continued at the same operating parameters until the target particle size (mean=0.11 microns and 99.0%<0.3 microns) was achieved.

A comparison of mean particle size between the two grinding processes is illustrated in the following table. The results clearly indicated that, to achieve the same mean particle size, Two-step grinding took less than half of the grind time than the One-Step grinding did.

Comparison of Grinding Efficiency between One-Step
and Two-Step Grinding

| | |
|---|---|
| Grinding Time, | Mean Particle Size, μm |

| Minutes | One-Step Process | Two-Step Process |
|---|---|---|
| 0 | 10.694 | 10.520 |
| 10 | 2.650 | 2.787 |
| 20 | 1.738 | 0.514 |
| 30 | 0.316 | 0.320 |
| 40 | 0.286 | 0.290 |
| 50 | 0.225 | 0.137* |
| 60 | 0.188 | 0.110 |
| 70 | 0.161 | |
| 80 | 0.151 | |
| 90 | 0.149 | |
| 100 | 0.145 | |
| 110 | 0.142 | |
| 120 | 0.140 | |
| 130 | 0.120 | |
| 140 | 0.116 | |
| 150 | 0.113 | |
| 160 | 0.111 | |
| 170 | 0.110 | |

*Grinding started with the smaller media in the Two-Step Process

### Example 2

### II A—One-Step Grinding Process

A 4000 g slurry mixture containing 1800 g of copper carbonate, 360 g of commercially available dispersant and 1840 g water was mechanically stirred for 10 minutes and then placed in a lab grinding media mill where a 0.2-0.3 mm Zirstar beads was used. The lab mill was operated at an agitation speed of 2400 to 2650 rpm and a transfer pump speed of 100-150 rpm. The temperature of the slurry was at 30° to 50° C. Samples were periodically taken for particle size measurement. The particle size was measured on a Horiba LA-910 Particle Size Distribution Analyzer (PSDA). The grinding process stopped at 1080 minutes when the target particle size was achieved. The target particle size was set at a mean particle=0.080 microns and 99.0% particles less than 0.20 microns.

### II B—Two-Step Grinding Process

The same copper carbonate mixture was placed in the lab mill and milled as the same condition as described in Example IA. After 30 minutes grinding, the grinding stopped when the mean particle achieved 0.157 microns with 100% particles less than 1.0 micron, and then the 0.2-0.3 mm grinding media were replaced with 0.1 mm YTZ grind media. The grinding continued at the same operating parameters until the target particle size was achieved.

A comparison of mean particle size between the two grinding processes is illustrated in the following table. The results clearly indicated that, to achieve the same mean particle size, Two-step grinding process significantly reduced the grinding time in comparison to the One-step grinding process.

Comparison of Grinding Efficiency between One-Step and
Two-Step Grinding

| | |
|---|---|
| Grinding Time, | Mean Particle Size, μm |

| Minutes | One-Step Process | Two-Step Process |
|---|---|---|
| 0 | 14.219 | 14.039 |
| 30 | 0.266 | 0.284 |
| 60 | 0.154 | 0.157* |
| 90 | 0.138 | 0.102 |
| 120 | 0.110 | 0.087 |
| 150 | 0.108 | 0.083 |
| 180 | 0.106 | 0.081 |
| 210 | 0.096 | 0.080 |
| 240 | 0.095 | |
| 300 | 0.093 | |
| 360 | 0.091 | |
| 420 | 0.090 | |
| 480 | 0.088 | |
| 600 | 0.085 | |
| 720 | 0.083 | |
| 840 | 0.082 | |
| 960 | 0.081 | |
| 1080 | 0.080 | |

*Grinding started with the smaller media in the Two-Step Process

### Example 3

### III A—One-Step Grinding Process

A 6000 g slurry mixture containing 3000 g of copper carbonate, 540 g of commercially available dispersant and 2460 g water was mechanically stirred for 20 minutes and then placed in a lab grinding media mill where a 0.1 mm YTZ beads was used. The lab mill was operated at an agitation speed of 2400 to 2650 rpm and a transfer pump speed of 100-150 rpm. The temperature of the slurry was at 30° to 50° C. Samples were periodically taken for particle size measurement. The particle size was measured on a Horiba LA-910 Particle Size Distribution Analyzer (PSDA). The grinding process stopped at 600 minutes when the target particle size was achieved. The target particle size was set at a mean particle=0.080 microns and 99.0% particles less than 0.20 microns.

### III B—Two-Step Grinding Process

The same copper carbonate mixture was prepared as Example III A, and then placed in the lab media mill where a 0.2-0.3 mm Zirstar beads was used. The lab mill was operated at an agitation speed of 2400 to 2650 rpm and a transfer pump speed of 100-150 rpm. The temperature of the slurry was at 30° to 50° C. After 90 minutes grinding, the grinding stopped when the mean particle achieved 0.161 microns with 100% particles less than 1.0 micron, and then the 0.2-0.3 mm grinding media were replaced with 0.1 mm YTZ grind media. The grinding continued at the same operating parameters until the target particle size was achieved.

A comparison of mean particle size between the two grinding processes is illustrated in the following table. The results clearly indicated that, to achieve the same mean particle size, Two-step grinding process significantly reduced the grinding time in comparison to the One-step grinding process.

Comparison of Grinding Efficiency between One-Step and
Two-Step Grinding

| | |
|---|---|
| Grinding Time, | Mean Particle Size, μm |

| Minutes | One-Step Process | Two-Step Process |
|---|---|---|
| 0 | 11.232 | 12.416 |
| 30 | 9.964 | 0.556 |
| 60 | 8.131 | 0.307 |
| 90 | 5.120 | 0.161* |
| 120 | 4.414 | 0.123 |
| 150 | 3.289 | 0.102 |
| 180 | 3.369 | 0.097 |
| 210 | 2.447 | 0.089 |
| 240 | 2.210 | 0.083 |
| 300 | 2.209 | 0.080 |
| 360 | 1.091 | |
| 420 | 0.471 | |
| 480 | 0.112 | |
| 600 | 0.080 | |

*Grinding started with the smaller media in the Two-Step Process

### Example 4

2000 g of copper carbonate powder was added to a container containing 1500 g of water and 500 g of a modified polyacrylate type of dispersant. The mixture was mechanically mixed for 15 minutes and then placed in a grinding media mill which was 90% pre-filled with 0.4-0.6 mm Zistar grinding media. The sample was ground for 60 minutes, and then the 0.4-0.6 mm grinding media was replaced with 0.1 mm YTZ and grinding continued for another 150 minutes. A stable fine particle dispersion was obtained, and the particle size was analyzed by Horiba LA-910. The mean particle size was 0.090 microns with 99.5% particles less than 0.30 microns.

### Example 5

3000 g of copper carbonate powder was added to a container containing 2460 g of water and 540 g of a modified polycarboxylate ether type of dispersant. The mixture was mechanically mixed for 15 minutes and then placed in a grinding media mill which was 90% pre-filled with 0.4-0.6 mm Zistar grinding media. The sample was ground for 60 minutes, and then the 0.4-0.6 mm grinding media was replaced with 0.1 mm YTZ and grinding continued for another 20 minutes. A stable fine particle dispersion was obtained, and the particle size was analyzed by Horiba LA-910. The mean particle size was 0.112 microns with 99.5% particles less than 0.30 microns.

### Example 6

3000 g of copper carbonate powder was added to a container containing 2460 g of water and 540 g of a modified polycarboxylate ether type of dispersant. The mixture was mechanically mixed for 15 minutes and then placed in a grinding media mill which was 90% pre-filled with 0.4-0.6 mm Zistar grinding media. The sample was ground for 90 minutes, and then the 0.4-0.6 mm grinding media was replaced with 0.1 mm YTZ and grinding continued for another 180 minutes. A stable fine particle dispersion was obtained, and the particle size was analyzed by Horiba LA-910. The mean particle size was 0.081 microns with 99.5% particles less than 0.20 microns.

### Example 7

1500 g of copper carbonate powder was added to a container containing 1300 g of water and 200 g of a modified polycarboxylate ether type of dispersant. The mixture was mechanically mixed for 5 minutes and then placed in a grinding media mill which was 90% pre-filled with 0.2-0.3 mm Zistar grinding media. The sample was ground for 30 minutes, and then the 0.2-0.3 mm grinding media was replaced with 0.1 mm YTZ and grinding continued for another 90 minutes. A stable fine particle dispersion was obtained, and the particle size was analyzed by Horiba LA-910. The mean particle size was 0.083 microns with 99.0% particles less than 0.20 microns.

### Example 8

2400 g of cuprous oxide powder was added to a container containing 1240 g of water and 360 g of a modified polyacrylate type of dispersant. The mixture was mechanically mixed for 15 minutes and then placed in a grinding media mill which was 90% pre-filled with 0.2-0.3 mm Zistar grinding media. The sample was ground for 10 minutes, and then the 0.2-0.3 mm grinding media was replaced with 0.1 mm YTZ and grinding continued for another 120 minutes. A stable fine particle dispersion was obtained, and the particle size was analyzed by Horiba LA-910. The mean particle size was 0.198 microns with 99.5% particles less than 1.0 micron.

### Example 9

1500 g of cuprous oxide powder was added to a container containing 775 g of water and 225 g of a modified polycarboxylate ether type of dispersant. The mixture was mechanically mixed for 15 minutes and then placed in a grinding media mill which was 90% pre-filled with 0.4-0.6 mm Zistar grinding media. The sample was ground for 15 minutes, and then the 0.4-0.6 mm grinding media was replaced with 0.1 mm YTZ and grinding continued for another 120 minutes. A stable fine particle dispersion was obtained, and the particle size was analyzed by Horiba LA-910. The mean particle size was 0.110 microns with 99.5% particles less than 1.0 micron.

### Example 10

A preservative treating fluid containing 1.0% CuO and 0.5% didecyidimethylammoinum carbone/bicarbonate was prepared by mixing the copper carbonate dispersion from Example 6 and a didecyidimethylammoinum carbone/bicarbonate concentrate. This fluid was allowed to mix until a homogenous fluid was prepared. The fluid was used to treat 8 pieces of 1.5″×5.5″×48″ hem fir lumbers using a modified treating cycle. The treating cycle included a 15 minute initial vacuum at approximate 27″ Hg, a 45 minute press at approximate 145 psi, and a 10 minute final vacuum at approximate 27″ Hg. After treatment, boring was taken from each treated pieces and evaluated for copper penetration according to the AWPA Standard A3-05 “Standard Method for Determining Penetration of Preservatives and Fire Retardants”. The results indicated the lumbers treated with the fine copper dispersion met the AWPA preservative penetration requirement for hem fir.

### Example 11

A preservative treating fluid containing 0.6% Cu and 0.024% tebuconazole was prepared by mixing the copper carbonate dispersion from Example 6 and a tebuconazole concentrate. This fluid was allowed to mix until a homogenous fluid was prepared. The fluid was used to treat 10 pieces of 1.5″×5.5″×48″ red pine lumbers using a modified treating cycle. The treating cycle included a 20 minute initial vacuum at approximate 27″ Hg, a 120 minute press at approximate 190 psi, and a 20 minute final vacuum at approximate 27″ Hg. After treatment, boring was taken from each treated pieces and evaluated for copper penetration according to the AWPA Standard A3-05 “Standard Method for Determining Penetration of Preservatives and Fire Retardants”. The results indicated the lumbers treated with the fine copper dispersion met the AWPA preservative penetration requirement for red pine.

Although specific embodiments have been described herein, those skilled in the art will recognize that routine modifications can be made without departing from the spirit of the invention.

What is claimed:

1. A method comprising the steps of:
a) providing a solid particle;
b) contacting the solid particle with a first grinding media;
c) milling the solid particle to produce a first milled particle;
d) contacting the first milled particle with a second grinding media; and
e) milling the first milled particle to produce a second milled particle.

2. The method of claim 1, wherein the solid particle is a metal or metal compound.

3. The method of claim 1, wherein the solid particle is an inorganic biocide.

4. The method of claim 1, wherein the solid particle further comprises one or more organic biocides.

5. The method of claim 2, wherein the metal is copper, cobalt, cadmium, nickel, tin, silver, zinc, lead, bismuth, chromium, arsenic, or combinations thereof.

6. The method of claim 5, wherein the metal is copper.

7. The method of claim 2, wherein the metal compound is a copper compound, cobalt compound, cadmium compound, nickel compound, tin compound, silver compound, zinc compound, lead compound, bismuth compound, chromium compound, arsenic compound, or combinations thereof.

8. The method of claim 7, wherein the metal compound is a copper compound.

9. The method of claim 8, wherein the copper compound is cuprous oxide, cupric oxide, copper hydroxide, copper carbonate, basic copper carbonate; copper oxychloride, copper 8-hydroxyquinolate, copper dimethyldithiocarbamate, copper omnadine, copper borate or combination thereof.

10. The method of claim 4, wherein the organic biocide is a fungicide, insecticide, moldicide, bactericide, algaecide, or combinations thereof.

11. The method of claim 10, wherein the one or more organic biocides is a quaternary ammonium compound, a triazole compound, an imidazole compound, a boron compound, an isothiazolone compound, a pyrethroid compound, or combination thereof.

12. The method of claim 10, wherein the organic biocide is imidachloprid, fipronil, cyfluthrin, bifenthrin, permethrin, cypermethrin, chlorpyrifos, iodopropynyl butylcarbamate (IPBC), chlorothalonil, 2-(thiocyanatomethylthio) benzothiazole, alkoxylated diamine, carbendazim, didecyldimethylammonium chloride, didecyldimethylammonium carbonate/bicarbonate, alkyldimethylbenzylammonium chloride, alkyldimethylbenzylammonium carbonate/bicarbonate, didodecyldimethylammonium chloride, didodecyldimethylammonium carbonate/bicarbonate, didodecyldimethylammonium propionate, N,N-didecyl-N-methyl-poly(oxyethyl)ammonium propionate, tebuconazole, cyproconazole, propiconazole, azaconazole, hexaconazole, tetraconazole or simeconazole, climbazole, imazalil or prochloraz.

13. The method of claim 1, wherein the first milled particle is micronized.

14. The method of claim 13, wherein the micronized particle has a mean particle size between 0.20 and 2.5 microns.

15. The method of claim 14, wherein the micronized particle has a mean particle size between 0.25 to 0.40 microns.

16. The method of claim 1, wherein the second milled particle has a mean particle size between 0.005 to 0.20 microns.

17. The method of claim 16, wherein the second milled particle has a mean particle size between 0.005 to 0.15 microns.

18. The method of claim 17, wherein the second milled particle has a mean particle size between 0.04 and 0.12 microns.

19. The method of claim 18, wherein the second milled particle has a mean particle size between 0.08 and 0.09 microns.

20. The method of claim 1, wherein the second milled particle has a mean particle size of 0.01, 0.02, 0.03, 0.04, 0.05, 0.06, 0.07, 0.08, 0.09, 0.10, 0.20, 0.30, 0.40, 0.50, 0.60, 0.70, 0.80, 0.90 or 1.0 microns.

21. The method of claim 1, wherein 90, 91, 92, 93, 94, 95, 96, 97, 98, 99, 99.1, 99.2, 99.3, 99.4, 99.5, 99.6, 99.7 99.8 or 99.9% of the second milled particle are less than 0.2 microns.

22. The method of claim 21, wherein the second milled particle has a mean particle size less than 0.1 microns.

23. The method of claim 21, wherein 99% of the second milled particles are less than 0.2 microns.

24. The method of claim 21, wherein 99% of the second milled particles are less than 0.1 microns.

25. The method of claim 1, wherein the diameter of the first grinding media is between 0.2 and 2.0 mm.

26. The method of claim 25, wherein the diameter of the first grinding media is between 0.3 and 1.0 mm.

27. The method of claim 25, wherein the diameter of the first grinding media is between 0.2 and 0.3 mm.

28. The method of claim 25, wherein the diameter of the first grinding media is between 0.4 and 0.6 mm.

29. The method of claim 25, wherein the diameter of the first grinding media is between 0.7 and 1.0 mm.

30. The method of claim 25, wherein the diameter of the first grinding media is between 1.0 and 1.5 mm.

31. The method of claim 25, wherein the diameter of the first grinding media is between 1.5 and 2.0 mm.

32. The method of claim 1, wherein the diameter of the second grinding media is between 0.005 and 0.2 mm.

33. The method of claim 32, wherein the diameter of the second grinding media is between 0.05 and 0.15 mm.

34. The method of claim 32, wherein the diameter of the second grinding media is between 0.1 and 0.2 mm.

35. The method of claim 32, wherein the diameter of the second grinding media is about 0.1 mm.

36. The method of claim 1, wherein the diameter of the first grinding media is 0.2 mm or larger.

37. The method of claim 1, wherein the diameter of the second grinding media is smaller than 0.2 mm.

38. The method of claim 1, wherein the diameter of the first grinding media is 0.2 mm or larger and the diameter of the second grinding media is smaller than 0.2 mm.

39. The method of claim 16, wherein milling time to produce the second milled particle is reduced compared to a milling method comprising only one milling step.

40. The method of claim 1, wherein the solid particle further comprises a carrier.

41. The method of claim 40, wherein the carrier is aqueous.

42. The method of claim 41, wherein the carrier further comprises a dispersant.

43. The method of claim 42, wherein the dispersant is polymeric.

44. The method of claim 42, wherein the dispersant is an acrylic copolymers, aqueous solution of copolymers with pigment affinity groups, polycarboxylate ether, modified polyacrylate or modified polyacrylate with groups of high pigment affinity, acrylic polymer emulsions, modified acrylic polymers, poly carboxylic acid polymers and their salts, modified poly carboxylic acid polymers and their salts, fatty acid modified polyester, aliphatic polyether or modified aliphatic polyether, solution of polycarboxylate ether, phosphate esters, phosphate ester modified polymers, polyglycol ethers or modified polyglycol ethers, polyetherphosphate, modified maleic anhydride/styrene copolymer, sodium polyacrylate, sodium polymethacrylate, lignin, or modified lignin.

45. The method of claim 1, wherein the grinding media is steel shots, carbon steel shots, stannous steel shots, chrome steel shots, tungsten carbide, silicon nitride, silicon, carbide, ceramic, zirconia, zirconium silicate, zirconium oxide, calcium stabilized zircona, magnesium stabilized zirconia, cerium-stabilized zirconia, stablized magnesium oxide, yttrium stabilized zirconia, or stabilized aluminum oxide.

46. The second milled particle produced by the method of claim 16.

47. A wood preservative composition comprising the particle of claim 46.

48. Wood comprising the particle of claim 46.

49. The particle of claim 46, further comprising an organic biocide.

50. A method to produce uniform distribution of solid particles in wood comprising the step of contacting the composition of claim 47 with wood.

51. A method of treating cellulosic material comprising the step of contacting the composition of claim 47 with a cellulosic material.

52. The method of claim 50, wherein the wood is resistant to decay and insect attack.

53. The method of claim 50, wherein the wood is a sapwood species.

54. The method of claim 53, wherein the sapwood species is southern pine, radiate pine, red pine, ponderosa pine, or Brazilian pine.

55. The method of claim 50, wherein the wood is a refractory species:

56. The method of claim 55, wherein refractory species is Douglas fir, hem fir, cedar, redwood or spruce.

57. The wood of claim 48, wherein the wood is a sapwood species.

58. The wood of claim 57, wherein the sapwood species is southern pine, radiate pine, red pine, ponderosa pine, or Brazilian pine.

59. The wood of claim 48, wherein the wood is refractory species.

60. The wood of claim 59, wherein the refractory species is Douglas fir, hem fir, cedar, redwood or spruce.
